(19) United States
(12) Patent Application Publication
(10) Pub. No.: US 2022/0411654 A1
(43) Pub. Date: Dec. 29, 2022

(54) Radiation Curable Inkjet Ink for Manufacturing Printed Circuit Boards

(71) Applicant: AGFA-GEVAERT NV, Mortsel (BE)

(72) Inventors: Marion Sauvageot, Mortsel (BE); Johan Loccufier, Mortsel (BE)

(73) Assignee: AGFA-GEVAERT NV, Mortsel (BE)

(21) Appl. No.: 17/774,674

(22) PCT Filed: Oct. 26, 2020
(86) PCT No.: PCT/EP2020/080059

§ 371 Date: May 5, 2022

(30) Foreign Application Priority Data
Nov. 7, 2019 (EP) 19207605.7

(51) Int. Cl. C09D 11/38; C09D 11/32

(52) U.S. Cl. CPC C09D 11/38; C09D 11/32

(57) ABSTRACT

The radiation curable inkjet ink comprises a polymerizable compound and at least one thioether functionalized adhesion promoter, at least one alkoxysilane adhesion promoter and at least one acid funtionalized adhesion promoter.

### TECHNICAL FIELD OF THE INVENTION

The present invention relates to radiation curable inkjet inks and inkjet methods for manufacturing Printed Circuit Boards.

### BACKGROUND ART FOR THE INVENTION

The production workflow of printed circuit boards (PCBs) is gradually shifting from the standard workflow towards a digital workflow to reduce the amount of process steps and lowering the cost and the environmental impact of the production of PCBs, especially for short run productions. Inkjet printing is a preferred digital manufacturing technology for different steps of the PCB manufacturing process, going from etch resist over solder mask to legend printing. Preferred inkjet inks are UV curable ink jet inks.

In the different production steps of PCBs, adhesion of the inkjet inks towards various substrates is of crucial importance. To maximize their adhesion, the inks often contain adhesion promoters.

Several classes of adhesion promoters have been disclosed in the prior art.

WO2004/026977 and WO2004/105 (Avecia) disclose an etch resistant inkjet ink comprising a (meth)acrylate functional monomer containing one or more acid groups, such as (meth)acrylated carboxylic acids, (meth)acrylated phosphoric acid esters and (meth)acrylated sulphonic acids.

EP-A 3119170 (Agfa Gevaert) discloses radiation curable inkjet inks used in PCB manufacturing comprising a silane compound as adhesion promoter.

EP-A 18159698.2 (filed on 2 Mar. 2018) and EP-A 18207145.6 (filed on 20 Nov. 2018) disclose radiation curable inkjet inks used in PCB manufacturing comprising thioether acrylate adhesion promoters.

When the radiation curable inkjet ink is used to produce a solder mask, the adhesion of the ink on several substrates has to survive the severe conditions used during soldering (solder resistance) and ENIG plating (plating resistance).

Especially the ENIG plating process wherein severe and varying conditions (pH and temperature) are used is very demanding as regard to the adhesion requirements of the inkjet ink.

Therefore, there is a need for radiation curable inkjet inks that can be used in a PCB manufacturing process and having a sufficient solder and ENIG resistance.

### SUMMARY OF THE INVENTION

It is an object of the invention to provide a radiation curable inkjet ink for use in a PCB manufacturing process characterized by a sufficient solder and ENIG resistance.

The object of the invention is realized by the radiation curable composition according to claim 1.

Further objects of the invention will become apparent from the description hereinafter.

### DETAILED DESCRIPTION OF THE INVENTION

### Definitions

The term “monofunctional” in e.g. monofunctional polymerizable compound means that the polymerizable compound includes one polymerizable group.

The term “difunctional” in e.g. difunctional polymerizable compound means that the polymerizable compound includes two polymerizable groups.

The term “polyfunctional” in e.g. polyfunctional polymerizable compound means that the polymerizable compound includes more than two polymerizable groups.

The term “alkyl” means all variants possible for each number of carbon atoms in the alkyl group i.e. methyl, ethyl, for three carbon atoms: n-propyl and isopropyl; for four carbon atoms: n-butyl, isobutyl and tertiary-butyl; for five carbon atoms: n-pentyl, 1,1-dimethyl-propyl, 2,2-dimethylpropyl and 2-methyl-butyl, etc.

Unless otherwise specified a substituted or unsubstituted alkyl group is preferably a C₁ to C₆-alkyl group.

Unless otherwise specified a substituted or unsubstituted alkenyl group is preferably a C₂ to C₆-alkenyl group.

Unless otherwise specified a substituted or unsubstituted alkynyl group is preferably a C₂ to C₆-alkynyl group.

Unless otherwise specified a substituted or unsubstituted alkaryl group is preferably a phenyl or naphthyl group including one, two, three or more C₁ to C₆-alkyl groups.

Unless otherwise specified a substituted or unsubstituted aralkyl group is preferably a C₇ to C₂₀-alkyl group including a phenyl group or naphthyl group.

Unless otherwise specified a substituted or unsubstituted aryl group is preferably a phenyl group or naphthyl group

Unless otherwise specified a substituted or unsubstituted heteroaryl group is preferably a five- or six-membered ring substituted by one, two or three oxygen atoms, nitrogen atoms, sulphur atoms, selenium atoms or combinations thereof.

The term “substituted”, in e.g. substituted alkyl group means that the alkyl group may be substituted by other atoms than the atoms normally present in such a group, i.e. carbon and hydrogen. For example, a substituted alkyl group may include a halogen atom or a thiol group. An unsubstituted alkyl group contains only carbon and hydrogen atoms

Unless otherwise specified a substituted alkyl group, a substituted alkenyl group, a substituted alkynyl group, a substituted aralkyl group, a substituted alkaryl group, a substituted aryl and a substituted heteroaryl group are preferably substituted by one or more constituents selected from the group consisting of methyl, ethyl, n-propyl, isopropyl, n-butyl, isobutyl and tertiary-butyl, ester, amide, ether, thioether, ketone, aldehyde, sulfoxide, sulfone, sulfonate ester, sulphonamide, —CI, —Br, —I, —OH, —SH, —CN and —NO₂.

### Radiation Curable Inkjet Ink

The radiation curable inkjet ink comprises a polymerizable compound and at least one thio-ether functionalized adhesion promoter, at least one alkoxysilane adhesion promoter and at least one acid functionalized adhesion promoter.

A thio-ether functionalized compound and an acid functionalized compound as used herein means respectively a thio-ether compound comprising at least one polymerizable group acid and an acid compound comprising at least one polymerizable group.

A di-or multifunctional compound as used herein means a compound comprising respectively two or more polymerizable groups.

The radiation curable inkjet ink may further comprise other ingredients such as photoinitiators, co-initiators, colorants, polymeric dispersants, a polymerization inhibitor, a flame retardant or a surfactant.

The total amount of adhesion promoters is preferably between 0.1 and 20 wt %, more preferably between 0.5 and 15 wt %, most preferably between 1 and 10 wt %, relative to the total weight of the inkjet ink.

When the amount is too low, the adhesion of the inkjet ink may be insufficient, when the amount is too high, the ink viscosity may increase and the shelf life may become more critical.

The radiation curable inkjet ink may be cured by any type of radiation, for example by electron-beam radiation, but is preferably cured by UV radiation, more preferably by UV radiation from UV LEDs. The radiation curable inkjet ink is thus preferably a UV curable inkjet ink.

For reliable industrial inkjet printing, the viscosity of the radiation curable inkjet ink is preferably no more than 20 mPa·s at 45° C., more preferably between 1 and 18 mPa·s at 45° C., and most preferably between 4 and 14 mPa·s at 45° C., all at a shear rate of 1000 s⁻¹.

A preferred jetting temperature is between 10 and 70° C., more preferably between 20 and 55° C., and most preferably between 25 and 50° C.

For good image quality and adhesion, the surface tension of the radiation curable inkjet ink is preferably in the range of 18 to 70 mN/m at 25° C., more preferably in the range of 20 to 40 mN/m at 25° C.

### Thio-ether Functionalized Adhesion Promoter

The thio-ether functionalized adhesion promoter is preferably a di-or multifunctional thio-ether according to Formula I or II.

According to a first embodiment, the thio-ether functionalized adhesion promoter has a chemical structure according to Formula I,

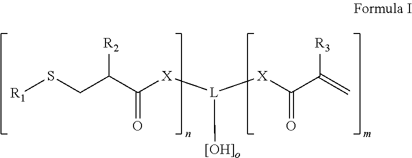

wherein

R₁ is selected from the group consisting of a substituted or unsubstituted alkyl group, a substituted or unsubstituted alkenyl group, a substituted or unsubstituted alkynyl group, a substituted or unsubstituted alkaryl group, a substituted or unsubstituted aralkyl group and a substituted or unsubstituted aryl or heteroaryl group;

R₂ and R₃ are independently selected from the group consisting of a hydrogen and a substituted or unsubstituted alkyl group;

L represents a n+m+o valent linking group;

n represents an integer from 1 to 9;

m represents an integer from 1 to 9;

o represents an integer from 0 to 8;

with the proviso that n+m+o is at maximum 10;

X represents an oxygen or N R₄;

R₄ is selected from the group consisting of a hydrogen, a substituted or unsubstituted alkyl group, a substituted or unsubstituted alkenyl group, a substituted or unsubstituted alkynyl group, a substituted or unsubstituted alkaryl group, a substituted or unsubstituted aralkyl group and a substituted or unsubstituted aryl or heteroaryl group.

R₁ is preferably selected from the group consisting of a substituted or unsubstituted alkyl group, a substituted or unsubstituted alkenyl group, a substituted or unsubstituted alkynyl group and a substituted or unsubstituted alkaryl group, a substituted or unsubstituted alkyl group being particularly preferred.

R₂ and R₃ are preferably independently selected from the group consisting of a hydrogen and a methyl group, a hydrogen being particularly preferred.

X preferably represents an oxygen or an NH, an oxygen being particularly preferred.

Preferably, n+m +o is 6 or less, more preferably 3 or 4.

Preferably, n and m are independently from each other 1 or 2.

Particularly preferred, n and m represent 2.

The adhesion promoters according to Formula I are preferably prepared by a catalyzed Michael addition to the activated double bonds of a polyfunctional monomer selected from the group consisting of an acrylate, a methacrylate, an acrylamide and a methacrylamide, an acrylate and a methacrylate being more preferred, an acrylate being the most preferred.

Different monomeric units selected from the group consisting of an acrylate, a methacrylate, an acrylamide and a methacrylamide may be present in said polyfunctional monomer.

The synthetic strategy typically leads to a mixture of adhesion promoters according to Formula I, which are preferably used in the ink without further purification.

According to a second embodiment, the thio-ether functionalized adhesion promoter has a chemical structure according to Formula II;

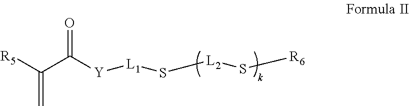

wherein

Y is selected from the group consisting of O and NR₇;

L₁ and L₂ independently represent a divalent linking group comprising from 2 to 20 carbon atoms;

R₅ is selected from the group consisting of a hydrogen, a substituted or unsubstituted alkyl group and a substituted or unsubstituted aryl group;

R₆ is selected from the group consisting of a substituted or unsubstituted alkyl group, a substituted or unsubstituted alkenyl group, a substituted or unsubstituted alkynyl group, a substituted or unsubstituted alkaryl group, a substituted or unsubstituted aralkyl group and a substituted or unsubstituted (hetero)aryl group;

R₇ is selected from the group consisting of a hydrogen, a substituted or unsubstituted alkyl group, a substituted or unsubstituted alkenyl group, a substituted or unsubstituted alkynyl group, a substituted or unsubstituted alkaryl group, a substituted or unsubstituted aralkyl group and a substituted or unsubstituted (hetero)aryl group;

k represents an integer from 1 to 4;

any of L₁, L₂ and R₆ may represent the necessary atoms to form a five to eight membered ring.

Preferably, Y represents an oxygen.

R₅ is preferably selected from the group consisting of a hydrogen and an alkyl group, a hydrogen and a methyl group being more preferred preferred, a hydrogen being the most preferred.

L₁ and L₂ preferably represent a substituted or unsubstituted alkylene group.

k preferably represents 1.

R₆ preferably comprises at least one polymerizable group selected from the group consisting of an acrylate, a methacrylate, an acrylamide and a methacrylamide, an acrylate and a methacrylate being more preferred, an acrylate being the most preferred.

The adhesion promoter preferably has a chemical structure according to Formula III,

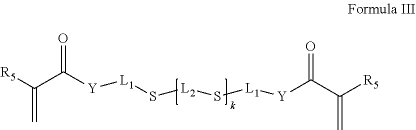

wherein

Y, R₅, L₁, L₂ and n are defined as above.

Examples of thio-ether-functionalized adhesion promoters are given in Table 1 without being limited hereto.

TABLE 1

| | |
|---|---|
| 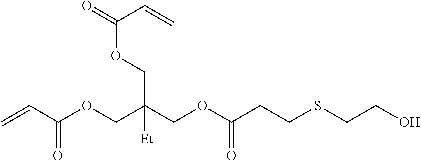 [SMILES: C=CC(=O)OCC(CC)(COC(=O)C=C)COC(=O)CCSCCO] | THIO-1 |
| 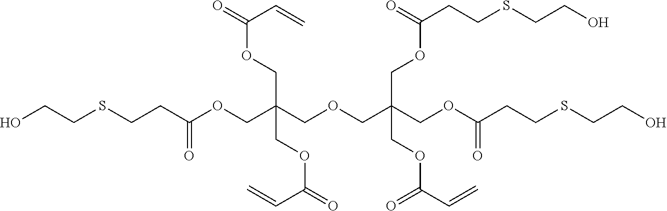 [SMILES: C=CC(=O)OCC(COCC(COC(=O)C=C)(COC(=O)CCSCCO)COC(=O)CCSCCO)(COC(=O)C=C)COC(=O)CCSCCO] | THIO-2 |
| 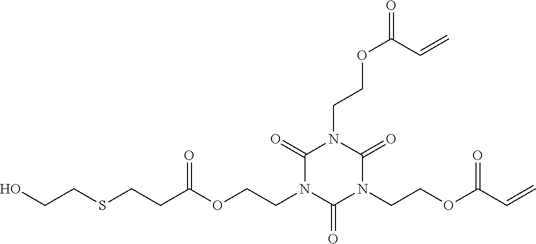 [SMILES: C=CC(=O)OCCn1c(=O)n(CCOC(=O)C=C)c(=O)n(CCOC(=O)CCSCCO)c1=O] | THIO-3 |
| 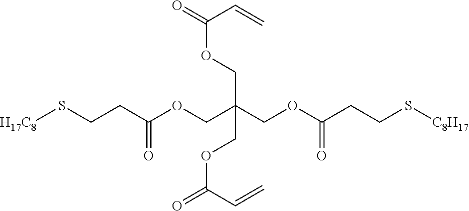 | THIO-4 |
| 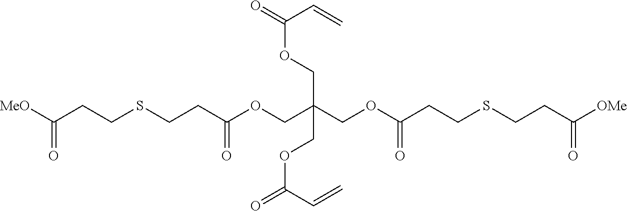 [SMILES: C=CC(=O)OCC(COC(=O)C=C)(COC(=O)CCSCCC(=O)OC)COC(=O)CCSCCC(=O)OC] | THIO-5 |
| 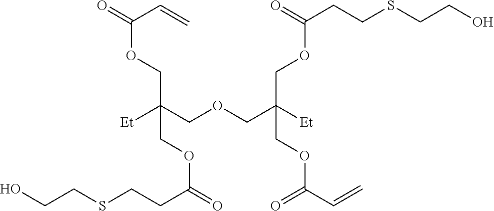 [SMILES: C=CC(=O)OCC(CC)(COCC(CC)(COC(=O)C=C)COC(=O)CCSCCO)COC(=O)CCSCCO] | THIO-6 |
| 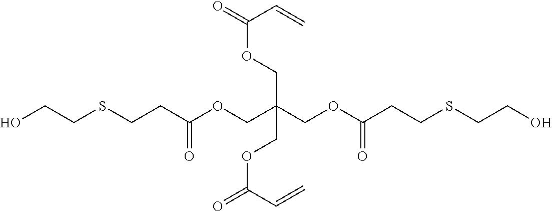 [SMILES: C=CC(=O)OCC(COC(=O)C=C)(COC(=O)CCSCCO)COC(=O)CCSCCO] | THIO-7 |
| 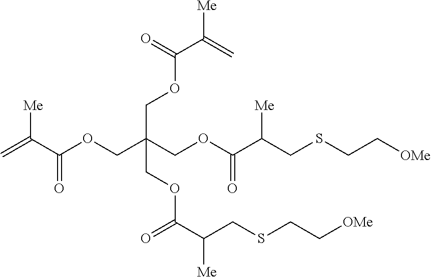 [SMILES: C=C(C)C(=O)OCC(COC(=O)C(=C)C)(COC(=O)C(C)CSCCOC)COC(=O)C(C)CSCCOC] | THIO-8 |
| 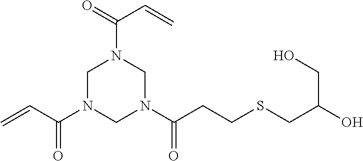 [SMILES: C=CC(=O)N1CN(C(=O)C=C)CN(C(=O)CCSCC(O)CO)C1] | THIO-9 |
| 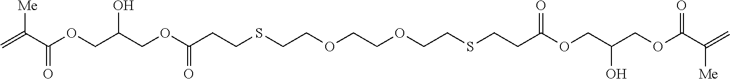 [SMILES: C=C(C)C(=O)OCC(O)COC(=O)CCSCCOCCOCCSCCC(=O)OCC(O)COC(=O)C(=C)C] | THIO-10 |
| 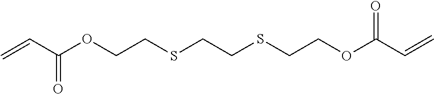 [SMILES: C=CC(=O)OCCSCCSCCOC(=O)C=C] | THIO-11 |
| 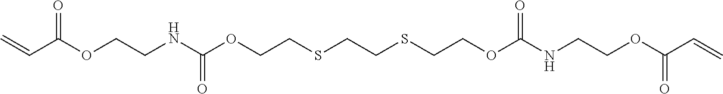 [SMILES: C=CC(=O)OCCNC(=O)OCCSCCSCCOC(=O)NCCOC(=O)C=C] | THIO-12 |
| 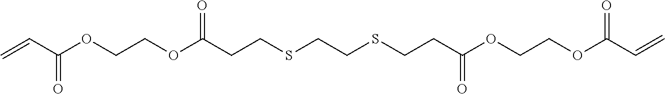 [SMILES: C=CC(=O)OCCOC(=O)CCSCCSCCC(=O)OCCOC(=O)C=C] | THIO-13 |

### Alkoxysilane Adhesion Promoter

The alkoxysilane adhesion promoter is preferably functionalized with a cyclic ether selected from the group consisting of an epoxide and an oxethane, an epoxide being more preferred.

The alkoxysilane is functionalized with at least on alkoxy group, more preferably at least two alkoxy groups and most preferably with three alkoxy groups.

The alkoxy groups are preferably C₁ to C₄ alkoxy groups, more preferably methoxy, ethoxy and isopropoxy groups, most preferably methoxy or ethoxy groups.

Typical examples of alkoxysilane adhesion promoters are given in Table 2 without being limited thereto.

TABLE 2

| | |
|---|---|
| 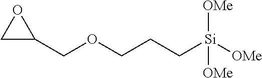 [SMILES: CO[Si](CCCOCC1CO1)(OC)OC] | SIL-1 |
| 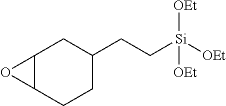 [SMILES: CCO[Si](CCC1CCC2OC2C1)(OCC)OCC] | SIL-2 |
| 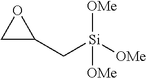 [SMILES: CO[Si](CC1CO1)(OC)OC] | SIL-3 |
| 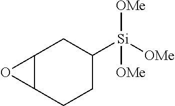 [SMILES: CO[Si](OC)(OC)C1CCC2OC2C1] | SIL-4 |
| 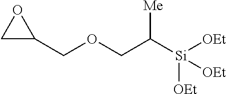 [SMILES: CCO[Si](OCC)(OCC)C(C)COCC1CO1] | SIL-5 |
| 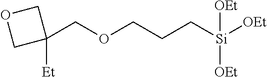 [SMILES: CCO[Si](CCCOCC1(CC)COC1)(OCC)OCC] | SIL-6 |
| 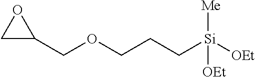 [SMILES: CCO[Si](C)(CCCOCC1CO1)OCC] | SIL-7 |
| 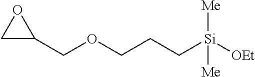 [SMILES: CCO[Si](C)(C)CCCOCC1CO1] | SIL-8 |

### Acid Funtionalized Adhesion Promoter

The functionalized acids are preferably carboxylic acids functionalized with a group selected from the group consisting of an acrylate, a methacrylate, an acryl amide, a methacryl amide, a styrene group, a vinyl ether, a vinyl ester, an allyl ether, an allyl ester, a maleimide and an itaconate.

The functional group is preferably selected from the group consisting of an acrylate, a methacrylate, an acryl amide and a methacryl amide.

The functional group is more preferably selected from the group consisting of an acrylate and a methacrylate.

The functional group is most preferably an acrylate group.

Typical acid functionalized adhesion promoters are given in Table 3 below without being limited thereto.

TABLE 3

| | |
|---|---|
| 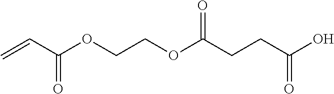 | ACID-1 |
| 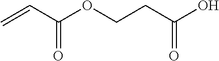 | ACID-2 |
| 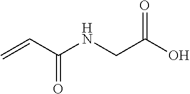 | ACID-3 |
| 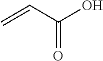 | ACID-4 |
| 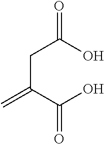 | ACID-5 |
| 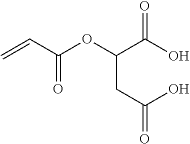 | ACID-6 |
| 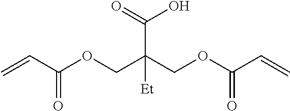 [SMILES: C=CC(=O)OCC(CC)(COC(=O)C=C)C(=O)O] | ACID-7 |
| 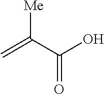 | ACID-8 |
| 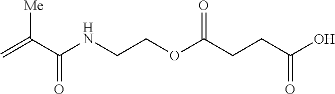 [SMILES: C=C(C)C(=O)NCCOC(=O)CCC(=O)O] | ACID-9 |
| 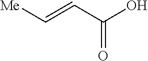 | ACID-10 |
| 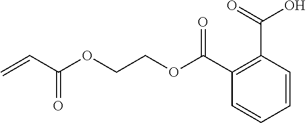 [SMILES: C=CC(=O)OCCOC(=O)c1ccccc1C(=O)O] | ACID-11 |

### Polymerizable Compounds

The polymerizable compounds are preferably free radical polymerizable compounds.

The free radical polymerizable compounds may be monomers, oligomers and/or prepolymers. Monomers are also referred to as diluents.

These monomers, oligomers and/or prepolymers may possess different degrees of functionality, i.e. a different amount of free radical polymerizable groups.

A mixture including combinations of mono-, di-, tri-and higher functional monomers, oligomers and/or prepolymers may be used. The viscosity of the radiation curable inkjet ink may be adjusted by varying the ratio between the monomers and oligomers.

In a preferred embodiment, the monomer, oligomer or polymer includes at least one acrylate group as polymerizable group.

Preferred monomers and oligomers are those listed in paragraphs [0106] to [0115] in EP-A 1911814.

In a preferred embodiment, the radiation curable inkjet ink comprises a monomer containing a vinyl ether group and an acrylate or methacrylate group. Such monomers are disclosed in EP-A 2848659, paragraphs [0099] to [0104]). A particular preferred monomer containing a vinyl ether group and an acrylate group is 2-(2-vinyloxyethoxy)ethyl acrylate.

The polymerizable compound is preferably selected from the group consisting of acryloyl morpholine, cyclic trimethyl propane formol acrylate, isobornyl acrylate, lauryl acrylate, dipropylene glycol diacrylate, trimethylol propane triacrylate, 2-(vinylethoxy)ethyl acrylate and urethane acrylate.

### Photoinitiators

The radiation curable inkjet preferably contains at least one photoinitiator.

The photoinitiator is preferably a free radical photoinitiator.

A free radical photoinitiator is a chemical compound that initiates polymerization of monomers and oligomers when exposed to actinic radiation by the formation of a free radical. A Norrish Type I initiator is an initiator which cleaves after excitation, yielding the initiating radical immediately. A Norrish type II-initiator is a photoinitiator which is activated by actinic radiation and forms free radicals by hydrogen abstraction from a second compound that becomes the actual initiating free radical. This second compound is called a polymerization synergist or co-initiator. Both type I and type II photoinitiators can be used in the present invention, alone or in combination.

Suitable photoinitiators are disclosed in CRIVELLO, J. V., et al. Photoinitiators for Free Radical, Cationic and Anionic Photopolymerization. 2nd edition. Edited by BRADLEY, G. London, UK: John Wiley and Sons Ltd, 1998. p.276-293.

Specific examples of free radical photoinitiators may include, but are not limited to, the following compounds or combinations thereof: benzophenone and substituted benzophenones; 1-hydroxycyclohexyl phenyl ketone; thioxanthones such as isopropylthioxanthone; 2-hydroxy-2-methyl-1-phenylpropan-1-one; 2-benzyl-2-dimethylamino-(4-morpholinophenyl) butan-1-one; benzyl dimethylketal; bis (2,6-dimethylbenzoyl)-2,4,4-trimethylpentylphosphine oxide; 2,4,6 trimethylbenzoyl-diphenylphosphine oxide; 2,4,6-trimethoxybenzoyldiphenylphosphine oxide; 2-methyl-1-[4-(methylthio) phenyl]-2-morpholinopropan-1-one; 2,2-dimethoxy-1, 2-diphenylethan-1-one or 5,7-diiodo-3-butoxy-6-fluorone.

A preferred amount of photoinitiator is 0.1-20 wt %, more preferably 2-15 wt %, and most preferably 3-10 wt % of the total weight of the radiation curable inkjet ink.

In order to increase the photosensitivity further, the radiation curable inkjet may additionally contain co-initiators. Suitable examples of co-initiators can be categorized in three groups: 1) tertiary aliphatic amines such as methyldiethanolamine, dimethylethanolamine, triethanolamine, triethylamine and N-methylmorpholine; (2) aromatic amines such as amylparadimethyl-aminobenzoate, 2-n-butoxyethyl-4-(dimethylamino) benzoate, 2-(dimethylamino)-ethylbenzoate, ethyl-4-(dimethylamino)benzoate, and 2-ethylhexyl-4-(dimethylamino)benzoate; and (3) (meth)acrylated amines such as dialkylamino alkyl(meth)acrylates (e.g., diethylaminoethylacrylate) or N-morpholinoalkyl-(meth)acrylates (e.g., N-morpholinoethyl-acrylate). The preferred co-initiators are aminobenzoates.

### Phenolic Compound

The radiation curable inkjet ink preferably comprises a phenolic compound, more preferably a phenolic compound comprising at least two phenolic groups. The phenolic compound may comprises two, three, four or more phenolic groups.

A preferred phenolic compound comprises two phenolic groups.

A particular preferred phenolic compound has a structure according to Formula IV:

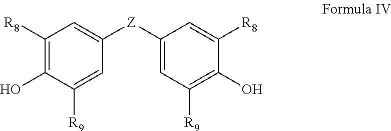

wherein

R₈ and R₉ are independently selected from the group consisting of a hydrogen atom, a substituted or unsubstituted alkyl group, a hydroxyl group and a substituted or unsubstituted alkoxy group;

Y is selected from the group consisting of CR₁₀R₁₁, SO₂, SO, S, O and CO;

R₁₀ and R₁₁ are independently selected from the group consisting of a hydrogen atom, a substituted or unsubstituted alkyl group, a substituted or unsubstituted alkenyl group, a substituted or unsubstituted alkynyl group, a substituted or unsubstituted alkaryl group, a substituted or unsubstituted aralkyl group, a substituted or unsubstituted (hetero)aryl group;

R₁₀ and R₁₁ may represent the necessary atoms to form a 5 to 8 membered ring.

Y is preferably CR₁₀R₁₁ or SO₂, R₁₀ and R₁₁ preferably represent a hydrogen atom or an alkyl group.

In another preferred embodiment, the phenolic compound is a polymer comprising at least two phenolic groups. Preferably, the polymer comprising at least two phenolic groups is a branched or hyperbranched polymer.

A preferred polymer comprising at least two phenolic groups is a phenolic resin, i.e. a novolac or a resole.

Phenolic resins are reaction products of phenolic compounds with aldehydes or ketones. Phenols which could be used are: phenol, o-cresol, p-cresol, m-cresol, 2,4-xylenol, 3,5-xylenol, or 2,5-xylenol. Aldehydes which can be used are formaldehyde, acetaldehyde, or acetone.

The most widely used method for novolac preparation is the acid-catalysed one-step synthesis of phenol/cresol and formaldehyde, which leads to a statistical structure of resin (see reaction scheme below).

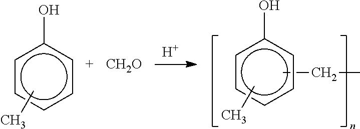

Generally, hydrochloric acid, sulfuric acid, p-toluene sulfuric acid or oxalic acid is used as catalyst. Various proportions of formaldehyde and phenol/cresol are usually employed in regular novolac resins. Higher phenol contents increase the degree of branching whereas reaction can take place at the ortho and para-positions. For resins with a higher p-cresol content more linear polymers are obtained due to that the para-position is blocked by presence of the methyl group.

Novolac copolymers of phenol and formaldehyde will have a high degree of branching, since reaction takes place both an ortho- and para-positions. In order to reduce the viscosity a high degree of branching and/or low molecular weights are preferred. For cresylic novolacs the use of m-cresol can give easier high molecular weights as compared to o-cresol and p-cresol.

Phenolic resins can also be prepared in base catalyzed reactions, which lead to the formation of resoles. Resoles are phenolic polymers having also methylol groups.

For incorporation in the solder mask inkjet ink, preference is given to novolac resins to obtain a sufficient ink stability since novolac resins are only reactive at high temperatures (>150 C). Resoles may react already at lower temperatures and due to the presence of methylol groups may result in a poorer chemical resistance of the inkjet ink.

More well defined branched polymers having at least two phenolic groups may be prepared using 4-hydroxyphenylmethylcarbinol, as disclosed in U.S. Pat. No. 5,554,719 and US2005250042. A particular preferred branched polymer having at least two phenolic groups prepared from 4-hydroxyphenylmethylcarbinol has been developed by Du Pont Electronic Polymers and is supplied by Hydrite Chemical Company under the tradename PB-5 (CASRN 166164-76-7).

Examples of phenolic compounds according to the present invention are given in Table 4 without being limited thereto.

TABLE 4

| | |
|---|---|
| 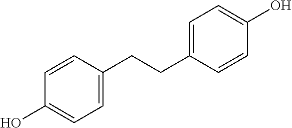 [SMILES: Oc1ccc(CCc2ccc(O)cc2)cc1] | PHEN-1 |
| 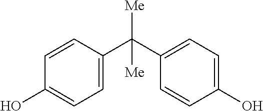 [SMILES: CC(C)(c1ccc(O)cc1)c1ccc(O)cc1] | PHEN-2 |
| 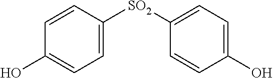 | PHEN-3 |
| 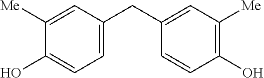 [SMILES: Cc1cc(Cc2ccc(O)c(C)c2)ccc1O] | PHEN-4 |
| 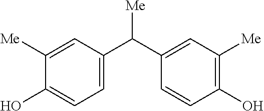 [SMILES: Cc1cc(C(C)c2ccc(O)c(C)c2)ccc1O] | PHEN-5 |
| 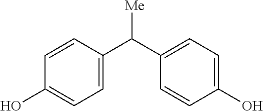 [SMILES: CC(c1ccc(O)cc1)c1ccc(O)cc1] | PHEN-6 |
| 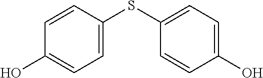 [SMILES: Oc1ccc(Sc2ccc(O)cc2)cc1] | PHEN-7 |
| 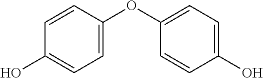 [SMILES: Oc1ccc(Oc2ccc(O)cc2)cc1] | PHEN-8 |
| 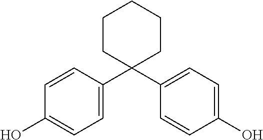 [SMILES: Oc1ccc(C2(c3ccc(O)cc3)CCCCC2)cc1] | PHEN-9 |
| 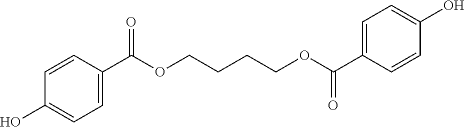 [SMILES: O=C(OCCCCOC(=O)c1ccc(O)cc1)c1ccc(O)cc1] | PHEN-10 |
| 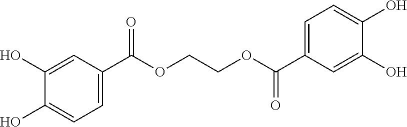 [SMILES: O=C(OCCOC(=O)c1ccc(O)c(O)c1)c1ccc(O)c(O)c1] | PHEN-11 |
| 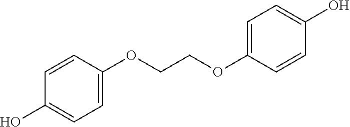 [SMILES: Oc1ccc(OCCOc2ccc(O)cc2)cc1] | PHEN-12 |
| 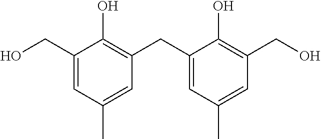 [SMILES: Cc1cc(CO)c(O)c(Cc2cc(C)cc(CO)c2O)c1] | PHEN-12 |
| 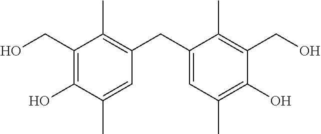 [SMILES: Cc1cc(Cc2cc(C)c(O)c(CO)c2C)c(C)c(CO)c1O] | PHEN-13 |
| 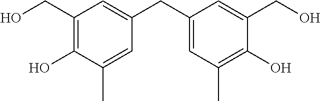 [SMILES: Cc1cc(Cc2cc(C)c(O)c(CO)c2)cc(CO)c1O] | PHEN-14 |
| 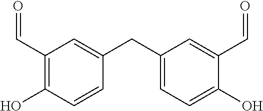 [SMILES: O=Cc1cc(Cc2ccc(O)c(C=O)c2)ccc1O] | PHEN-15 |
| 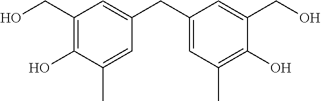 [SMILES: Cc1cc(Cc2cc(C)c(O)c(CO)c2)cc(CO)c1O] | PHEN-16 |
| 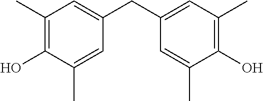 [SMILES: Cc1cc(Cc2cc(C)c(O)c(C)c2)cc(C)c1O] | PHEN-17 |
| 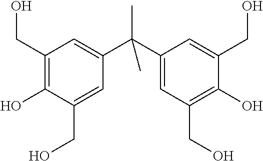 [SMILES: CC(C)(c1cc(CO)c(O)c(CO)c1)c1cc(CO)c(O)c(CO)c1] | PHEN-18 |
| 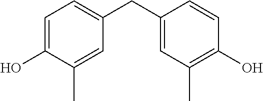 [SMILES: Cc1cc(Cc2ccc(O)c(C)c2)ccc1O] | PHEN-19 |
| 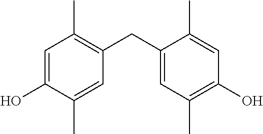 [SMILES: Cc1cc(Cc2cc(C)c(O)cc2C)c(C)cc1O] | PHEN-20 |
| 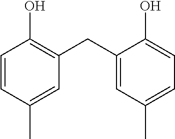 [SMILES: Cc1ccc(O)c(Cc2cc(C)ccc2O)c1] | PHEN-21 |
| 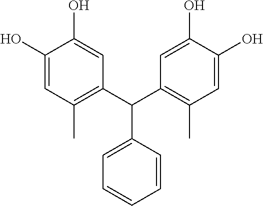 [SMILES: Cc1cc(O)c(O)cc1C(c1ccccc1)c1cc(O)c(O)cc1C] | PHEN-22 |
| 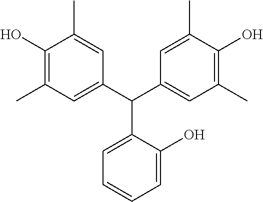 [SMILES: Cc1cc(C(c2cc(C)c(O)c(C)c2)c2ccccc2O)cc(C)c1O] | PHEN-23 |
| 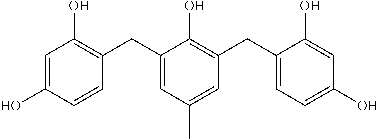 [SMILES: Cc1cc(Cc2ccc(O)cc2O)c(O)c(Cc2ccc(O)cc2O)c1] | PHEN-24 |
| 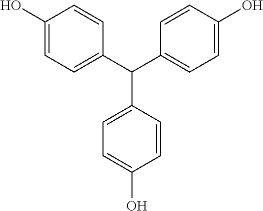 [SMILES: Oc1ccc(C(c2ccc(O)cc2)c2ccc(O)cc2)cc1] | PHEN-25 |
| 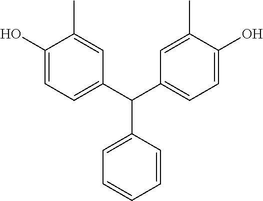 [SMILES: Cc1cc(C(c2ccccc2)c2ccc(O)c(C)c2)ccc1O] | PHEN-26 |
| 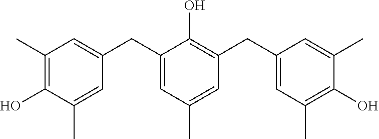 [SMILES: Cc1cc(Cc2cc(C)c(O)c(C)c2)c(O)c(Cc2cc(C)c(O)c(C)c2)c1] | PHEN-27 |
| 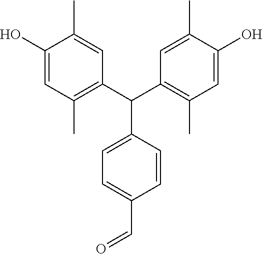 [SMILES: Cc1cc(C(c2ccc(C=O)cc2)c2cc(C)c(O)cc2C)c(C)cc1O] | PHEN-28 |
| 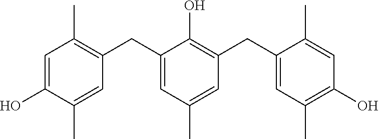 [SMILES: Cc1cc(Cc2cc(C)c(O)cc2C)c(O)c(Cc2cc(C)c(O)cc2C)c1] | PHEN-29 |
| 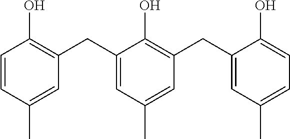 [SMILES: Cc1ccc(O)c(Cc2cc(C)cc(Cc3cc(C)ccc3O)c2O)c1] | PHEN-30 |
| 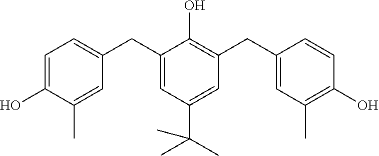 [SMILES: Cc1cc(Cc2cc(C(C)(C)C)cc(Cc3ccc(O)c(C)c3)c2O)ccc1O] | PHEN-31 |
| 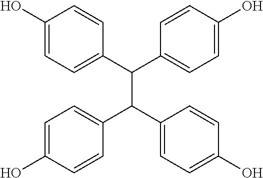 [SMILES: Oc1ccc(C(c2ccc(O)cc2)C(c2ccc(O)cc2)c2ccc(O)cc2)cc1] | PHEN-32 |
| 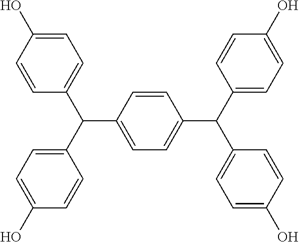 [SMILES: Oc1ccc(C(c2ccc(O)cc2)c2ccc(C(c3ccc(O)cc3)c3ccc(O)cc3)cc2)cc1] | PHEN-33 |
| 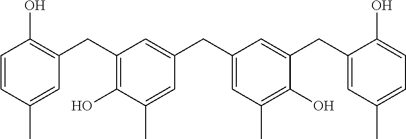 [SMILES: Cc1ccc(O)c(Cc2cc(Cc3cc(C)c(O)c(Cc4cc(C)ccc4O)c3)cc(C)c2O)c1] | PHEN-34 |
| 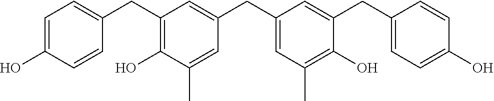 [SMILES: Cc1cc(Cc2cc(C)c(O)c(Cc3ccc(O)cc3)c2)cc(Cc2ccc(O)cc2)c1O] | PHEN-35 |
| 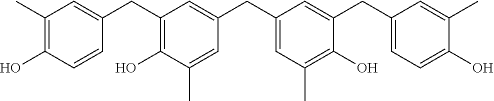 [SMILES: Cc1cc(Cc2cc(Cc3cc(C)c(O)c(Cc4ccc(O)c(C)c4)c3)cc(C)c2O)ccc1O] | PHEN-36 |
| 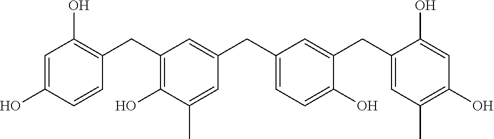 [SMILES: Cc1cc(Cc2cc(Cc3cc(C)c(O)c(Cc4ccc(O)cc4O)c3)ccc2O)c(O)cc1O] | PHEN-37 |
| 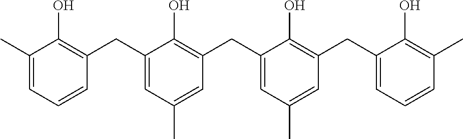 | PHEN-38 |
| 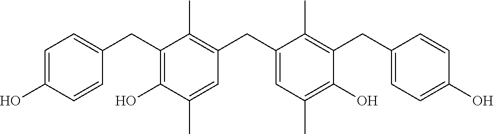 [SMILES: Cc1cc(Cc2cc(C)c(O)c(Cc3ccc(O)cc3)c2C)c(C)c(Cc2ccc(O)cc2)c1O] | PHEN-39 |
| 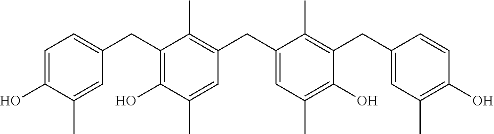 [SMILES: Cc1cc(Cc2c(C)c(Cc3cc(C)c(O)c(Cc4ccc(O)c(C)c4)c3C)cc(C)c2O)ccc1O] | PHEN-40 |
| 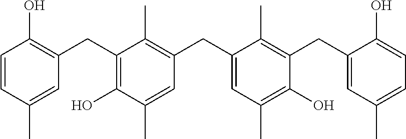 [SMILES: Cc1ccc(O)c(Cc2c(C)c(Cc3cc(C)c(O)c(Cc4cc(C)ccc4O)c3C)cc(C)c2O)c1] | PHEN-41 |
| 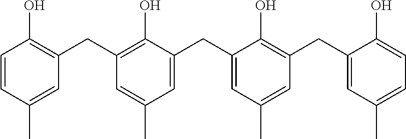 [SMILES: Cc1ccc(O)c(Cc2cc(C)cc(Cc3cc(C)cc(Cc4cc(C)ccc4O)c3O)c2O)c1] | PHEN-42 |

Typical examples of polymers having at least two phenolic groups are given in Table 5 below without being limited thereto.

TABLE 5

| | |
|---|---|
| 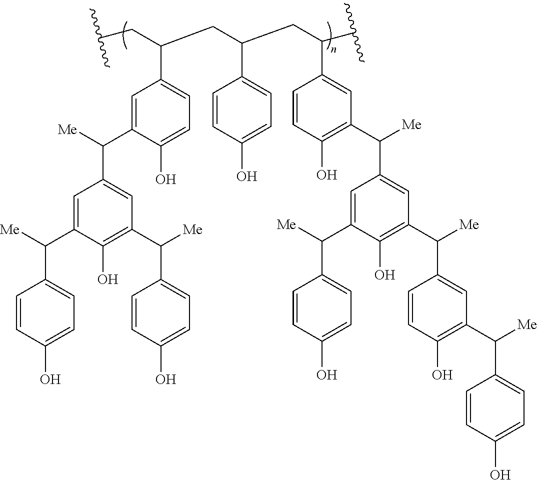 | RESIN-1 |
| 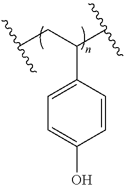 | RESIN-2 |
| 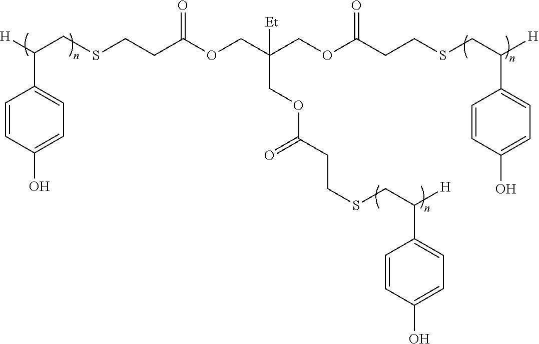 | RESIN-3 |
| 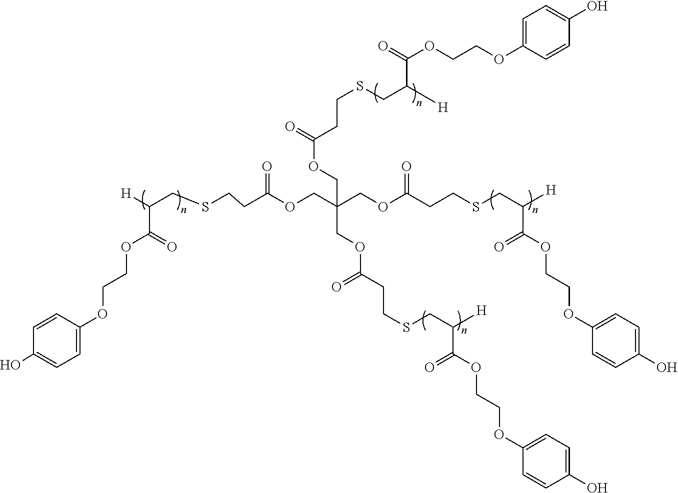 | RESIN-4 |

The amount of phenolic compounds is preferably between 0.5 and 20 wt %, more preferably between 1 and 15 wt %, most preferably between 2.5 and 10 wt %, relative to the total weight of the inkjet ink.

### Colorants

The radiation curable inkjet may be a substantially colourless inkjet ink or may include at least one colorant. For example when the inkjet ink is used as etch resist, the colorant makes the temporary mask clearly visible to the manufacturer of conductive patters, allowing a visual inspection of quality. When the inkjet ink is used to apply a solder mask it typically contains a colorant. A preferred colour for a solder mask is green, however other colours such as black or red may also be used.

The colorant may be a pigment or a dye.

A colour pigment may be chosen from those disclosed by HERBST, Willy, et al.

Industrial Organic Pigments, Production, Properties, Applications. 3rd edition. Wiley—VCH, 2004. ISBN 3527305769. Suitable pigments are disclosed in paragraphs to [0138] of WO2008/074548.

Pigment particles in inkjet inks should be sufficiently small to permit free flow of the ink through the inkjet-printing device, especially at the ejecting nozzles. It is also desirable to use small particles for maximum colour strength and to slow down sedimentation. Most preferably, the average pigment particle size is no larger than 150 nm. The average particle size of pigment particles is preferably determined with a Brookhaven Instruments Particle Sizer BI90plus based upon the principle of dynamic light scattering.

Generally dyes exhibit a higher light fading than pigments, but cause no problems on jettability. It was found that anthraquinone dyes exhibit only minor light fading under the normal UV curing conditions used in UV curable inkjet printing. In a preferred embodiment, the colorant in the radiation curable inkjet ink is an anthraquinone dye, such as Macrolex™ Blue 3R (CASRN 325781-98-4) from LANXESS.

Other preferred dyes include crystal violet and a copper phthalocyanine dye.

In a preferred embodiment, the colorant is present in an amount of 0.5 to 6.0 wt %, more preferably 1.0 to 2.5 wt %, based on the total weight of the radiation curable inkjet ink.

### Polymeric Dispersants

If the colorant in the radiation curable inkjet is a pigment, then the radiation curable inkjet preferably contains a dispersant, more preferably a polymeric dispersant, for dispersing the pigment.

Suitable polymeric dispersants are copolymers of two monomers but they may contain three, four, five or even more monomers. The properties of polymeric dispersants depend on both the nature of the monomers and their distribution in the polymer. Copolymeric dispersants preferably have the following polymer compositions:
statistically polymerized monomers (e.g. monomers A and B polymerized into ABBAABAB);
alternating polymerized monomers (e.g. monomers A and B polymerized into ABABABAB);
gradient (tapered) polymerized monomers (e.g. monomers A and B polymerized into AAABAABBABBB);
block copolymers (e.g. monomers A and B polymerized into AAAAABBBBBB) wherein the block length of each of the blocks (2, 3, 4, 5 or even more) is important for the dispersion capability of the polymeric dispersant;
graft copolymers (graft copolymers consist of a polymeric backbone with polymeric side chains attached to the backbone); and
mixed forms of these polymers, e.g. blocky gradient copolymers.

Suitable polymeric dispersants are listed in the section on “Dispersants”, more specifically [0064] to [0070] and [0074] to [0077], in EP-A 1911814.

Commercial examples of polymeric dispersants are the following:
DISPERBYK™ dispersants available from BYK CHEMIE GMBH;
SOLSPERSE™ dispersants available from NOVEON;
TEGO™ DISPERS™ dispersants from EVONIK;
EDAPLAN™ dispersants from MÜNZING CHEMIE;
ETHACRYL™ dispersants from LYONDELL;
GANEX™ dispersants from ISP;
DISPEX™ and EFKA™ dispersants from CIBA SPECIALTY CHEMICALS INC;
DISPONER™ dispersants from DEUCHEM; and
JONCRYL™ dispersants from JOHNSON POLYMER.

### Polymerization Inhibitors

The radiation curable inkjet ink may contain at least one inhibitor for improving the thermal stability of the ink.

Suitable polymerization inhibitors include phenol type antioxidants, hindered amine light stabilizers, phosphor type antioxidants, hydroquinone monomethyl ether commonly used in (meth)acrylate monomers, and hydroquinone, t-butyl-catechol, pyrogallol, 2,6-di-tert.butyl-4-methylphenol (═BHT) may also be used.

Suitable commercial inhibitors are, for example, Sumilizer™ GA-80, Sumilizer™ GM and Sumilizer™ GS produced by Sumitomo Chemical Co. Ltd.; Genorad™ 16, Genorad™18 and Genorad™ 20 from Rahn AG; Irgastab™UV10 and Irgastab™ UV22, Tinuvin™ 460 and CGS20 from Ciba Specialty Chemicals; Floorstab™ UV range (UV-1, UV-2, UV-5 and UV-8) from Kromachem Ltd, Additol™ S range (S100, S110, S120 and S130) from Cytec Surface Specialties.

The inhibitor is preferably a polymerizable inhibitor.

Since excessive addition of these polymerization inhibitors may lower the curing speed, it is preferred that the amount capable of preventing polymerization is determined prior to blending. The amount of a polymerization inhibitor is preferably lower than 5 wt %, more preferably lower than 3 wt % of the total radiation curable inkjet ink.

### Surfactants

The radiation curable inkjet may contain at least one surfactant.

The surfactant can be anionic, cationic, non-ionic, or zwitter-ionic and is usually added in a total quantity less than 1wt % based on the total weight of the radiation curable inkjet ink.

Suitable surfactants include fluorinated surfactants, fatty acid salts, ester salts of a higher alcohol, alkylbenzene sulfonate salts, sulfosuccinate ester salts and phosphate ester salts of a higher alcohol (for example, sodium dodecylbenzenesulfonate and sodium dioctylsulfosuccinate), ethylene oxide adducts of a higher alcohol, ethylene oxide adducts of an alkylphenol, ethylene oxide adducts of a polyhydric alcohol fatty acid ester, and acetylene glycol and ethylene oxide adducts thereof (for example, polyoxyethylene nonylphenyl ether, and SURFYNOL™ 104, 104H, 440, 465 and TG available from AIR PRODUCTS & CHEMICALS INC.).

Preferred surfactants are selected from fluoric surfactants (such as fluorinated hydrocarbons) and silicone surfactants. The silicone surfactants are preferably siloxanes and can be alkoxylated, polyether modified, polyether modified hydroxy functional, amine modified, epoxy modified and other modifications or combinations thereof. Preferred siloxanes are polymeric, for example polydimethylsiloxanes.

Preferred commercial silicone surfactants include BYK™ 333 and BYK™ UV3510 from BYK Chemie.

In a preferred embodiment, the surfactant is a polymerizable compound.

Preferred polymerizable silicone surfactants include a (meth)acrylated silicone surfactant. Most preferably the (meth)acrylated silicone surfactant is an acrylated silicone surfactant, because acrylates are more reactive than methacrylates.

In a preferred embodiment, the (meth)acrylated silicone surfactant is a polyether modified (meth)acrylated polydimethylsiloxane or a polyester modified (meth)acrylated polydimethylsiloxane.

Preferably the surfactant is present in the radiation curable inkjet ink in an amount of 0 to 3 wt % based on the total weight of the radiation curable inkjet ink.

### Flame Retardant

Preferred flame retardants are inorganic flame retardants, such as Alumina Trihydrate and Boehmite, and organo-phosphor compounds, such as organo-phosphates (e.g. triphenyl phosphate (TPP), resorcinol bis (diphenylphosphate) (RDP), bisphenol A diphenyl phosphate (BADP), and tricresyl phosphate (TCP)); organo-phosphonates (e.g. dimethyl methylphosphonate (DMMP)); and organophosphinates (e.g. aluminium dimethylphosphinate).

Other preferred organo-phosphor compounds are disclosed in U.S. Pat. No. 8,273,805 (JNC Corporation)) and EP-A 3498788 (Agfa Gevaert).m

[symbol]

### Preparation of Inkjet Inks

The preparation of pigmented radiation curable inkjet inks is well-known to the skilled person. Preferred methods of preparation are disclosed in paragraphs [0076] to [0085] of WO2011/069943.

### Method of Manufacturing a Printed Circuit Board

The method of manufacturing a Printed Circuit Board (PCB) according to the present invention includes an inkjet printing step wherein a radiation curable inkjet ink as described above is jetted and cured on a substrate.

According to a preferred embodiment, the method of manufacturing a PCB comprises an inkjet printing step wherein a solder mask is provided.

The solder mask is provided by jetting and curing the radiation curable inkjet ink typically on a dielectric substrate containing an electrically conductive pattern.

A heat treatment is preferably applied to the jetted and cured radiation curable inkjet ink. The heat treatment is preferably carried out at a temperature between 80° C. and 250° C. The temperature is preferably not less than 100° C., more preferably not less than 120° C. To prevent charring of the solder mask, the temperature is preferably not greater than 200° C., more preferably not greater than 160° C.

The thermal treatment is typically carried out between 15 and 90 minutes.

The purpose of the thermal treatment is to further increase the polymerization degree of the solder mask.

The dielectric substrate of the electronic device may be any non-conductive material. The substrate is typically a paper/resin composite or a resin/fibre glass composite, a ceramic substrate, a polyester or a polyimide.

The electrically conductive pattern is typically made from any metal or alloy which is conventionally used for preparing electronic devices such as gold, silver, palladium, nickel/gold, nickel, tin, tin/lead, aluminium, tin/aluminium and copper. The electrically conductive pattern is preferably made from copper.

The radiation curable inkjet ink may be cured by exposing the ink to actinic radiation, such as electron beam or ultraviolet (UV) radiation. Preferably the radiation curable inkjet ink is cured by UV radiation, more preferably using UV LED curing.

The method of manufacturing a PCB may comprise two, three or more inkjet printing steps. For example the method may comprise two inkjet printing steps wherein an etch resist is provided on a metal surface in one inkjet printing step and wherein a solder mask is provided on a dielectric substrate containing an electrically conductive pattern in another inkjet printing step.

A third inkjet printing step may be used for legend printing.

### Inkjet Printing Devices

The radiation curable inkjet ink may be jetted by one or more print heads ejecting small droplets in a controlled manner through nozzles onto a substrate, which is moving relative to the print head(s).

A preferred print head for the inkjet printing system is a piezoelectric head. Piezoelectric inkjet printing is based on the movement of a piezoelectric ceramic transducer when a voltage is applied thereto. The application of a voltage changes the shape of the piezoelectric ceramic transducer in the print head creating a void, which is then filled with ink. When the voltage is again removed, the ceramic expands to its original shape, ejecting a drop of ink from the print head. However the inkjet printing method according to the present invention is not restricted to piezoelectric inkjet printing. Other inkjet print heads can be used and include various types, such as a continuous type.

The inkjet print head normally scans back and forth in a transversal direction across the moving ink-receiving surface (substrate). Often the inkjet print head does not print on the way back. Bi-directional printing is preferred for obtaining a high areal throughput. Another preferred printing method is by a “single pass printing process”, which can be performed by using page wide inkjet print heads or multiple staggered inkjet print heads which cover the entire width of the ink-receiving surface. In a single pass printing process the inkjet print heads usually remain stationary and the ink-receiving surface is transported under the inkjet print heads.

### Curing Devices

The radiation curable inkjet ink can be cured by exposing them to actinic radiation, such as electron beam or ultraviolet radiation. Preferably the radiation curable inkjet ink is cured by ultraviolet radiation, more preferably using UV LED curing.

In inkjet printing, the curing means may be arranged in combination with the print head of the inkjet printer, travelling therewith so that the curable liquid is exposed to curing radiation very shortly after been jetted.

In such an arrangement, with the exception of UV LEDs, it can be difficult to provide a small enough radiation source connected to and travelling with the print head. Therefore, a static fixed radiation source may be employed, e.g. a source of curing UV-light, connected to the radiation source by means of flexible radiation conductive means such as a fibre optic bundle or an internally reflective flexible tube.

Alternatively, the actinic radiation may be supplied from a fixed source to the radiation head by an arrangement of mirrors including a mirror upon the radiation head.

The source of radiation may also be an elongated radiation source extending transversely across the substrate to be cured. It may be adjacent the transverse path of the print head so that the subsequent rows of images formed by the print head are passed, stepwise or continually, beneath that radiation source.

Any ultraviolet light source, as long as part of the emitted light can be absorbed by the photo-initiator or photo-initiator system, may be employed as a radiation source, such as, a high or low pressure mercury lamp, a cold cathode tube, a black light, an ultraviolet LED, an ultraviolet laser, and a flash light. Of these, the preferred source is one exhibiting a relatively long wavelength UV-contribution having a dominant wavelength of 300-400 nm. Specifically, a UV-A light source is preferred due to the reduced light scattering therewith resulting in more efficient interior curing.

UV radiation is generally classed as UV-A, UV-B, and UV-C as follows:
UV-A: 400 nm to 320 nm
UV-B: 320 nm to 290 nm
UV-C: 290 nm to 100 nm.

In a preferred embodiment, the radiation curable inkjet ink is cured by UV LEDs. The inkjet printing device preferably contains one or more UV LEDs preferably with a wavelength larger than 360 nm, preferably one or more UV LEDs with a wavelength larger than 380 nm, and most preferably UV LEDs with a wavelength of about 395 nm.

Furthermore, it is possible to cure the ink image using, consecutively or simultaneously, two light sources of differing wavelength or illuminance. For example, the first UV-source can be selected to be rich in UV-C, in particular in the range of 260 nm-200 nm. The second UV-source can then be rich in UV-A, e.g. a gallium-doped lamp, or a different lamp high in both UV-A and UV-B. The use of two UV-sources has been found to have advantages e.g. a fast curing speed and a high curing degree.

For facilitating curing, the inkjet printing device often includes one or more oxygen depletion units. The oxygen depletion units place a blanket of nitrogen or other relatively inert gas (e.g. CO₂), with adjustable position and adjustable inert gas concentration, in order to reduce the oxygen concentration in the curing environment. Residual oxygen levels are usually maintained as low as 200 ppm, but are generally in the range of 200 ppm to 1200 ppm.

### EXAMPLES

### Materials

All materials used in the following examples were readily available from standard sources such as ALDRICH CHEMICAL Co. (Belgium) and ACROS (Belgium) unless otherwise specified. The water used was deionized water.

CTFA is a cyclic trimethylpropane formal acrylate available as Sartomer™ SR531 from ARKEMA.

ACMO is acryloyl morpholine available from RAHN.

VEEA is 2-(vinylethoxy)ethyl acrylate available from NIPPON SHOKUBAI, Japan.

SR335 is a lauryl acrylate available as Sartomer™ SR335 from ARKEMA.

SR833S is a low viscosity difunctional acrylate monomer available as Sartomer™ SR833S from ARKEMA.

EBECRYL220 is a hexafunctional aromatic urethane acrylate available as Ebecryl®220 from ALLNEX.

TMPTA is trimethylolpropane triacrylate available as Sartomer™ SR351 from ARKEMA.

PB5 is a branched poly(4-hydroxystyrene) available as PB5 from HYDRITE CHEMICAL COMPANY.

BAPO is a bis(2,4,6-trimethylbenzoyl)-phenylphosphineoxide photoinitiator available as Irgacure™ 819 from BASF.

ITX is Speedcure™ ITX, a mixture of isopropyl thioxanthone isomers, from LAMBSON SPECIALTY CHEMICALS.

EPD is ethyl-4-(dimethylamino)benzoate, available under the trade name of Genocure™ EPD from RAHN AG.

ACID-1 is acrylic acid 99.5% from ACROS.

SIL-1 is 3-glycidoxypropyltrimethoxy, available as Silane Z-6040 from DOW CORNING.

Ascorbic Acid is available from MERCK.

SIL-C1 is vinyltrimethoxysilane available as Silquest VX-193 from MOMENTIVE.

THIO-C1 is a thiol compound having a chemical structure as shown below and prepared according to EP-A 3321331, paragraph [0149]-[0150]).

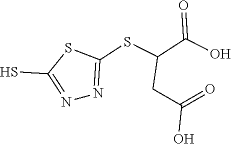 [SMILES: O=C(O)CC(Sc1nnc(S)s1)C(=O)O]

Octanoic acid is available from ACROS (99.5 purity).

Benzoic acid is available from MERCK.

INHIB is a mixture forming a polymerization inhibitor having a composition according to Table 6.

TABLE 6

| Component | wt % |
|---|---|
| DPGDA | 82.4 |
| p-methoxyphenol | 4.0 |
| 2,6-di-tert-butyl-4-methylphenol | 10.0 |
| Cupferron ™ AL | 3.6 |

Cupferron™ AL is aluminum N-nitrosophenylhydroxylamine from WAKO CHEMICALS LTD.

DPGDA is dipropylenediacrylate, available as Sartomer SR508 from ARKEMA.

Ebecryl 1360 is a polysiloxane hexa acrylate slip agent from ALLNEX.

Cyan is SUN FAST BLUE 15:4, a cyan pigment available from SUN CHEMICALS.

Yellow is CROMOPHTAL YELLOW D 1085J, a yellow pigment from BASF.

Disperbyk 162 is a dispersing agent and has been precipitated from a solution available from BYK (ALTANA).

FRO1 is a flame retardant commercially available under tradename ADK Stab FP600 from ADEKA PALMAROL.

### Methods

### Viscosity

The viscosity of the inks was measured at 45° C. and at a shear rate of 1000 s⁻¹, using a “Robotic Viscometer Type VISCObot” from CAMBRIDGE APPLIED SYSTEMS.

For industrial inkjet printing, the viscosity at 45° C. and at a shear rate of 1000 s⁻¹, is preferably between 5.0 and 15 mPa·s. More preferably the viscosity at 45° C. and at a shear rate of 1000 s⁻¹, is less than 15 mPa·s.

### Adhesion of the Inkjet Inks

The adhesion was evaluated according to the IS02409:1992 Paints and varnishes cross-cut test (International standard 1992 Aug. 15) using a Braive No.1536 Cross Cut Tester from BRAIVE INSTRUMENTS with spacing of a 1 mm between cuts and using a weight of 600 g, in combination with a Tesatape™ 4104 PVC tape. The evaluation was made in accordance with a criterion described in Table 7, where both the adhesion in the cross-cut and outside the cross-cut were evaluated.

TABLE 7

| Evaluation | |
|---|---|
| value | Criterion |
| 0 | Nothing removed, perfect adhesion. |
| 1 | Detachment of only very small parts of |
| | the cured layer, almost perfect adhesion. |
| 2 | Minor parts of the cured layer was |
| | removed by the tape, good adhesion |
| 3 | Parts of the cured layer were removed |
| | by the tape, poor adhesion. |
| 4 | Most of the cured layer was removed |
| | by the tape, poor adhesion. |
| 5 | The cured layer was completely removed |
| | from the substrate by the tape, no adhesion. |

### Solder Resistance

The solder resistance of the inkjet inks was evaluated using a SPL600240 Digital Dynamic Solder Pot available from L&M PRODUCTS filled with a “K” Grade 63:37 tin/lead solder available from SOLDER CONNECTION. The temperature of the solder was set at 290° C.

Using a Q-tip, a solder flux SC7560A from SOLDER CONNECTION was applied on the surface of the samples (i.e. coatings of the inkjet ink on a copper surface as described under adhesion) to clean the surface. The solder flux was dried by placing the samples for 10 minutes above the solder pot.

After placing the sample in the solder pot, a solder wave was created for 10 seconds after which the samples were cooled for at least 10 minutes.

The adhesion of the inkjet inks was then evaluated as described above.

### ENIG Resistance

First of all, the boards were dipped in a bath of acid cleaner (Umicore cleaner 865) at 40° C. during 4 min. The boards were then removed and dipped in a rinsing bath of deionized water (DW) at room temperature (RT) during 90 s.

Secondly the boards were dipped in a microetching bath comprising 8.5 wt %

Na2S208 and ±3.2 wt % H2SO4 (98%) in water at a temperature between 26-33° C. for 100 s. The boards were then removed and dipped in a rinsing bath of DW at RT during 90 s.

Thirdly the boards were dipped in a palladium activator bath (Accemulta MKN 4) at a temperature around 30° C. for 90 s. The boards were then removed and dipped in a rinsing bath of DW at RT during 90 s.

Then the boards were dipped in a nickel bath (Nimuden NPR 4) at a temperature around 85° C. for 35 min. The boards were then removed and dipped in a rinsing bath of DW at RT during 90 s.

Finally, the boards were dipped in a gold bath (Gobright TAM 55) at a temperature around 80° C. for 12 min. The boards were then removed and dipped in a rinsing bath of DW at RT during 90 s.

The adhesion of the solder mask inkjet inks was then evaluated as described above.

### Synthesis of Thio-7 in a Mixture of thio-ethers (THIOMIX-7)

The thioether acrylates according to the present invention were analyzed on an AmaZon™ SL mass spectrometer (supplied by Brüker Daltonics), using an Alltech Alltima C18 (150 mm×3.2 mm) column at a flow rate of 0.5 ml/min at a temperature of 40° C. and ESI as ionisation technique.

A gradient elution was used as shown in Table 8 using Eluent A (10 mmol formic acid in water) and Eluent B (10 mmol formic acid in acetonitrile).

TABLE 8

| Elution | % |
|---|---|
| time (min) | eluent B |
| 0 | 0 |
| 13 | 100 |
| 30 | 100 |

The reaction scheme is shown below.

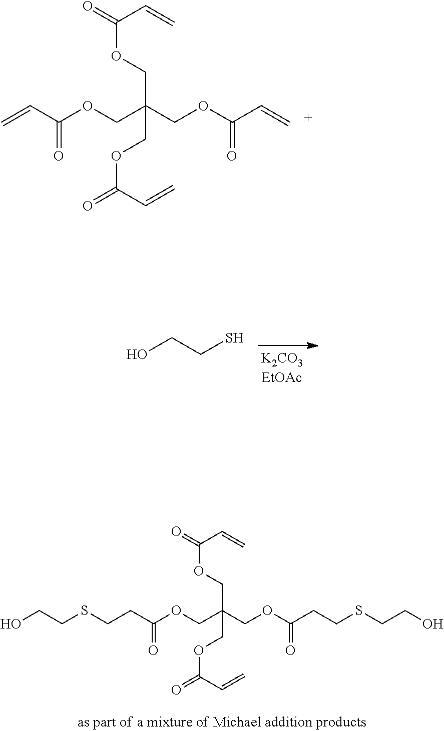

105.7 g (0.3 mol) pentaerythritol tetraacrylate was dissolved in 450 ml ethyl acetate. 0.44 g BHT and 20.7 g (0.15 mol) potassium carbonate were added and the mixture was strirred at room temperature. A solution of 46.8 g (0.6 mol) 2-mercapto-ethanol in 150 ml ethylacetate was added and the mixture was refluxed for four and a half hour. The mixture was allowed to cool down to room temperature. The potassium carbonate was removed by filtration and the solvent was removed under reduced pressure. 150 g of a mixture of Michael addition products was isolated as a viscous oil.

THIOMIX-7 was characterized using LC-MS as described above. The proposed structures in Table 9 below are based on molecular mass. An isomeric structure based on this molecular mass can be considered as a potential alternative structure.

TABLE 9

| Retention time | Structure (or potential isomer) | Area % |
|---|---|---|
| 7.885 | 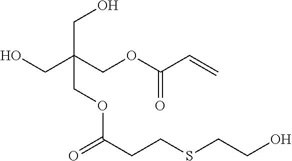 [SMILES: C=CC(=O)OCC(CO)(CO)COC(=O)CCSCCO] | 2.13 |
| 8.993 | 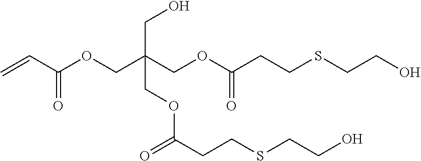 [SMILES: C=CC(=O)OCC(CO)(COC(=O)CCSCCO)COC(=O)CCSCCO] | 4.46 |
| 9.584 | 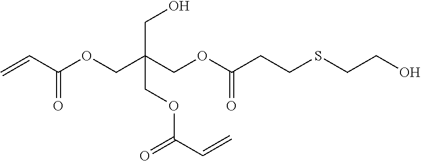 [SMILES: C=CC(=O)OCC(CO)(COC(=O)C=C)COC(=O)CCSCCO] | 5.41 |
| 9.750 | 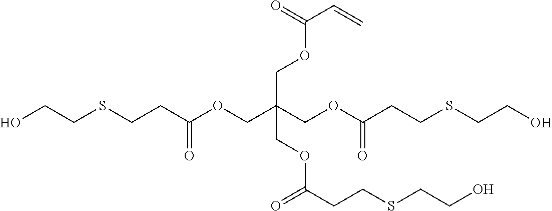 [SMILES: C=CC(=O)OCC(COC(=O)CCSCCO)(COC(=O)CCSCCO)COC(=O)CCSCCO] | 4.07 |
| 10.363 | 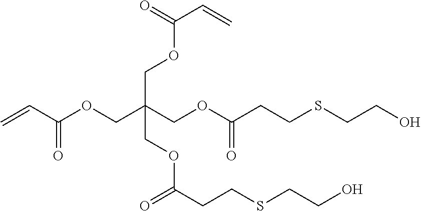 [SMILES: C=CC(=O)OCC(COC(=O)C=C)(COC(=O)CCSCCO)COC(=O)CCSCCO] | 17.16 |
| 10.555 | 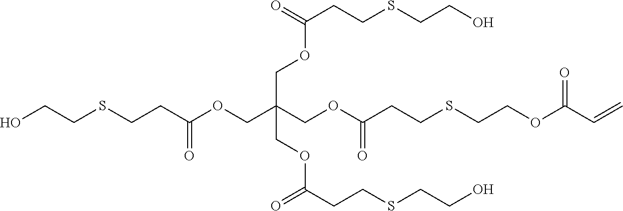 [SMILES: C=CC(=O)OCCSCCC(=O)OCC(COC(=O)CCSCCO)(COC(=O)CCSCCO)COC(=O)CCSCCO] | 2.75 |
| 11.117 | 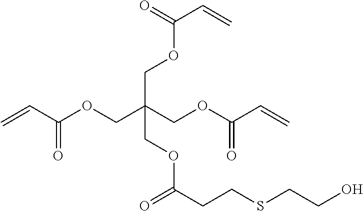 [SMILES: C=CC(=O)OCC(COC(=O)C=C)(COC(=O)C=C)COC(=O)CCSCCO] | 18.68 |
| 11.895 | 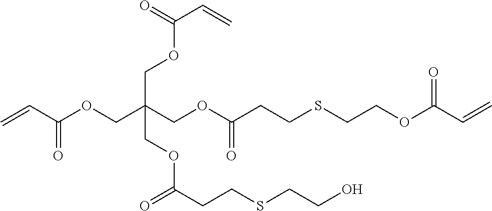 [SMILES: C=CC(=O)OCCSCCC(=O)OCC(COC(=O)C=C)(COC(=O)C=C)COC(=O)CCSCCO] | 3.77 |
| 12.038 | 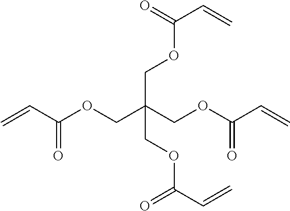 [SMILES: C=CC(=O)OCC(COC(=O)C=C)(COC(=O)C=C)COC(=O)C=C] | 10.77 |

As can be seen from the mixture above, THIOMIX-7 is formed based on a combination of Michael addition reactions and transesterification reactions, leading to a complex mixture of thio-ethers according to the present invention.

The mixture was used in ink formulations without purification.

### Example 1

This example illustrates that an UV curable inkjet ink according to the present invention may be used as a solder mask inkjet ink combining a good adhesion towards copper and a sufficient solder and ENIG resistance.

### Preparation Green Pigment Dispersion GPD

A concentrated Green pigment dispersions, GPD, was prepared having a composition according to Table 10.

TABLE 10

| GPD | wt % |
|---|---|
| Cyan | 7.5 |
| Yellow | 7.5 |
| Disperbyk 162 | 15 |
| INHIB | 1 |
| VEEA | 69 |

GPD was prepared as follows: 138 g of 2-(2-vinyloxyethoxy)ethyl acrylate, 2 g of a solution containing 4 wt % of 4-methoxyphenol, 10 wt % of 2,6-di-tert-butyl-4-methylphenol and 3,6 wt % of Aluminum-N-nitroso phenylhydroxyl amine in dipropylene glycol diacrylate and 30 g of Cyan and 30 g of Yellow were mixed using a DISPERLUX™ dispenser. Stirring was continued for 30 minutes. The vessel was connected to a NETZCH MiniZeta mill filled with 900 g of 0.4 mm yttrium stabilized zirconia beads (“high wear resistant zirconia grinding media” from TOSOH Co.). The mixture was circulated over the mill over 120 minutes (residence time of 45 minutes) and a rotation speed in the mill of about 10.4 m/s. During the complete milling procedure the content in the mill was cooled to keep the temperature below 60° C. After milling, the dispersion was discharged into a vessel.

### Preparation of Comparative Inks COMP-1 to COMP-18 and Inventive Ink INV-1

The comparative radiation curable inkjet ink COMP-1 to COMP-18 and the inventive radiation curable inkjet ink INV-lwere prepared according to Table 11. The weight percentages (wt %) are all based on the total weight of the radiation curable inkjet ink.

TABLE 11

| wt % of component | COMP-1 | INV-1 | COMP-2 | COMP-3 | COMP-4 |
|---|---|---|---|---|---|
| GPD | 6.60 | = | = | = | = |
| CTFA | 8.00 | = | = | = | = |
| ACMO | 5.00 | = | = | = | = |
| VEEA | 40.40 | 35.40 | = | = | = |
| SR335 | 5.00 | = | = | = | = |
| SR833S | 10.00 | = | = | = | = |
| Ebecryl 220 | 3.00 | = | = | = | = |
| TMPTA | 5.00 | = | = | = | = |
| PB5 | 4.00 | = | = | = | = |
| BAPO | 2.00 | = | = | = | = |
| ITX | 4.00 | = | = | = | = |
| EPD | 4.00 | = | = | = | = |
| Ebecryl 1360 | 0.10 | = | = | = | = |
| INHIB | 0.90 | = | = | = | = |
| FR01 | 2.00 | = | = | = | = |
| ACID-1 | — | 1.00 | 2.50 | 2.50 | — |
| SIL-1 | — | 2.00 | 2.50 | — | 2.50 |
| THIOMIX-7 | — | 2.00 | — | 2.50 | 2.50 |
| wt % of component | COMP-5 | COMP-6 | COMP-7 | COMP-8 | COMP-9 |
| GPD | 6.60 | = | = | = | = |
| CTFA | 8.00 | = | = | = | = |
| ACMO | 5.00 | = | = | = | = |
| VEEA | 35.40 | = | = | = | = |
| SR335 | 5.00 | = | = | = | = |
| SR833S | 10.00 | = | = | = | = |
| Ebecryl 220 | 3.00 | = | = | = | = |
| TMPTA | 5.00 | = | = | = | = |
| PB5 | 4.00 | = | = | = | = |
| BAPO | 2.00 | = | = | = | = |
| ITX | 4.00 | = | = | = | = |
| EPD | 4.00 | = | = | = | = |
| Ebecryl 1360 | 0.10 | = | = | = | = |
| INHIB | 0.90 | = | = | = | = |
| FR01 | 2.00 | = | = | = | = |
| ACID-1 | 5.00 | — | — | — | 1.00 |
| SIL-1 | — | 5.00 | — | 2.00 | — |
| THIOMIX-7 | — | — | 5.00 | — | 2.00 |
| Ascorbic acid | — | — | — | 1.00 | — |
| THIO-C1 | — | — | — | 2.00 | — |
| SIL-C1 | | | | | 2.00 |
| wt % of component | COMP-10 | COMP-11 | COMP-12 | COMP-13 | COMP-14 |
| GPD | 6.60 | = | = | = | = |
| CTFA | 8.00 | = | = | = | = |
| ACMO | 5.00 | = | = | = | = |
| VEEA | 35.40 | = | = | = | = |
| SR335 | 5.00 | = | = | = | = |
| SR833S | 10.00 | = | = | = | = |
| Ebecryl 220 | 3.00 | = | = | = | = |
| TMPTA | 5.00 | = | = | = | = |
| PB5 | 4.00 | = | = | = | = |
| BAPO | 2.00 | = | = | = | = |
| ITX | 4.00 | = | = | = | = |
| EPD | 4.00 | = | = | = | = |
| Ebecryl 1360 | 0.10 | = | = | = | = |
| INHIB | 0.90 | = | = | = | = |
| FR01 | 2.00 | = | = | = | = |
| ACID-1 | 1.00 | — | — | — | — |
| SIL-1 | 2.00 | — | — | — | — |
| THIO-C1 | 2.00 | 2.00 | — | — | 5.00 |
| Ascorbic Acid | — | 1.00 | 5.00 | — | — |
| SIL-C1 | — | 2.00 | — | 5.00 | — |

| wt % of component | COMP-15 | COMP-16 | COMP-17 | COMP-18 |
|---|---|---|---|---|
| GPD | 6.60 | = | = | = |
| CTFA | 8.00 | = | = | = |
| ACMO | 5.00 | = | = | = |
| VEEA | 35.40 | = | = | = |
| SR335 | 5.00 | = | = | = |
| SR833S | 10.00 | = | = | = |
| Ebecryl 220 | 3.00 | = | = | = |
| TMPTA | 5.00 | = | = | = |
| PB5 | 4.00 | = | = | = |
| BAPO | 2.00 | = | = | = |
| ITX | 4.00 | = | = | = |
| EPD | 4.00 | = | = | = |
| Ebecryl 1360 | 0.10 | = | = | = |
| INHIB | 0.90 | = | = | = |
| FR01 | 2.00 | = | = | = |
| SIL-1 | — | — | 2.00 | — |
| THIOMIX-7 | — | — | 2.00 | — |
| Ascorbic acid | — | — | — | — |
| SIL-C1 | — | — | — | 2.00 |
| Octanoic acid | 5.00 | — | 1.00 | 1.00 |
| Benzoic acid | — | 5.00 | — | — |
| THIO-C1 | — | — | — | 2.00 |

The comparative samples COMP-1 to COMP-18 and the inventive sample INV-1 were obtained by jetting the inks on a 35 μm brushed Cu laminate CCI Eurolam or a brushed FR laminate CCI Eurolam using an Anapurna M2050i (8 pass, 45° C. jetting temperature, 15% pincure after each pass and 100% pincure UV bump to fully cure the surface, using a LED 395 nm lamp). Additionally a thermal cure at 150° C. during 60 minutes was performed.

The adhesion, solder resistance and ENIG resistance of the inks were tested as described above. The results are shown in Table 12.

TABLE 12

| UV curable | Adhesion | | Solder Resistance | | ENIG Resistance | |
|---|---|---|---|---|---|---|
| inkjet ink | Cu | FR4 | Cu | FR4 | Cu | FR4 |
| COMP-1 | 2 | 0 | 1 | 3 | 4 | 5 |
| INV-1 | 0 | 0 | 0 | 0 | 1 | 0 |
| COMP-2 | 0 | 0 | 0 | 1 | 2 | 0 |
| COMP-3 | 1 | 0 | 0 | 5 | 3 | 5 |
| COMP-4 | 0 | 0 | 1 | 1 | 5 | 5 |
| COMP-5 | 0 | 0 | 1 | 5 | 1 | 4 |
| COMP-6 | 0 | 0 | 1 | 0 | 3 | 5 |
| COMP-7 | 2 | 0 | 3 | 3 | 5 | 5 |
| COMP-8 | NO STABLE INKS | | | | | |
| COMP-9 | 0 | 3 | 0 | 2 | 2 | 3 |
| COMP-10 | 2 | 1 | 0 | 1 | 3 | 3 |
| COMP-11 | NO STABLE INKS | | | | | |
| COMP-12 | NO STABLE INKS | | | | | |
| COMP-13 | 0 | 5 | 0 | 5 | 3 | 5 |
| COMP-14 | 0 | 5 | 0 | 5 | 4 | 5 |
| COMP-15 | 0 | 5 | 4 | 5 | 5 | 5 |
| COMP-16 | 0 | 5 | 0 | 5 | 2 | 5 |
| COMP-17 | 0 | 4 | 0 | 5 | 1 | 5 |
| COMP-18 | 0 | 5 | 2 | 4 | 2 | 5 |

It is clear from the results of Table 12 that the inventive solder mask inkjet ink containing three adhesion promoters according to the present invention has improved solder and ENIG resistance.

1-15. (canceled)

16. A radiation curable inkjet ink comprising a polymerizable compound characterized in that the inkjet ink includes at least one thio-ether functionalized adhesion promoter, at least one alkoxysilane adhesion promoter, and at least one acid functionalized adhesion promoter.

17. The radiation curable inkjet ink of claim 16, wherein the thio-ether functionalized adhesion promoter has a chemical formula according to Formula I or II, 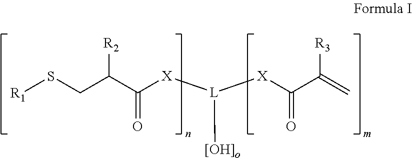
wherein
R₁ is selected from the group consisting of a substituted or unsubstituted alkyl group, a substituted or unsubstituted alkenyl group, a substituted or unsubstituted alkynyl group, a substituted or unsubstituted alkaryl group, a substituted or unsubstituted aralkyl group, and a substituted or unsubstituted aryl or heteroaryl group;
R₂ and R₃ are each independently selected from the group consisting of a hydrogen and a substituted or unsubstituted alkyl group;
L represents a n+m+o valent linking group;
n represents an integer in the range from 1 to 9;
m represents an integer in the range from 1 to 9;
o represents an integer in the range from 0 to 8;
with the proviso that n+m+o is less than or equal to 10;
X represents an oxygen or NR₄;
R₄ is selected from the group consisting of a hydrogen, a substituted or unsubstituted alkyl group, a substituted or unsubstituted alkenyl group, a substituted or unsubstituted alkynyl group, a substituted or unsubstituted alkaryl group, a substituted or unsubstituted aralkyl group, and a substituted or unsubstituted aryl or heteroaryl group; 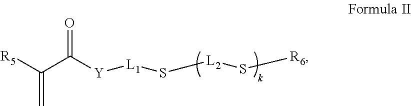
wherein
Y is selected from the group consisting of O and NR₇;
L₁ and L₂ each independently represent a divalent linking group comprising from 2 to 20 carbon atoms;
R₅ is selected from the group consisting of a hydrogen, a substituted or unsubstituted alkyl group, and a substituted or unsubstituted aryl group;
R₆ is selected from the group consisting of a substituted or unsubstituted alkyl group, a substituted or unsubstituted alkenyl group, a substituted or unsubstituted alkynyl group, a substituted or unsubstituted alkaryl group, a substituted or unsubstituted aralkyl group, and a substituted or unsubstituted (hetero)aryl group;
R₇ is selected from the group consisting of a hydrogen, a substituted or unsubstituted alkyl group, a substituted or unsubstituted alkenyl group, a substituted or unsubstituted alkynyl group, a substituted or unsubstituted alkaryl group, a substituted or unsubstituted aralkyl group, and a substituted or unsubstituted (hetero)aryl group;
k represents an integer in the range from 1 to 4; and
any of L₁, L₂, and R₆ may represent the necessary atoms to form a five to eight membered ring.

18. The radiation curable inkjet ink of claim 17, wherein the thio-ether functionalized adhesion promoter has a chemical formula according to Formula III, 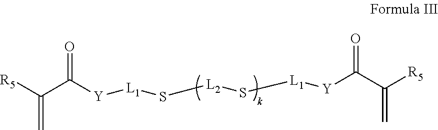
wherein
Y is selected from the group consisting of O and NR₇;
L₁ and L₂ each independently represent a divalent linking group comprising from 2 to 20 carbon atoms;
R₅ is selected from the group consisting of a hydrogen, a substituted or unsubstituted alkyl group, and a substituted or unsubstituted aryl group;
R₇ is selected from the group consisting of a hydrogen, a substituted or unsubstituted alkyl group, a substituted or unsubstituted alkenyl group, a substituted or unsubstituted alkynyl group, a substituted or unsubstituted alkaryl group, a substituted or unsubstituted aralkyl group, and a substituted or unsubstituted (hetero)aryl group;
k represents an integer in the range from 1 to 4; and
any of L₁ and L₂ may represent the necessary atoms to form a five to eight membered ring.

19. The radiation curable inkjet ink of claim 16, wherein the alkoxysilane adhesion promoter is functionalized with a cyclic ether selected from the group consisting of an epoxide and an oxethane.

20. The radiation curable inkjet ink of claim 16, wherein the acid functionalized adhesion promoter is a carboxylic acid functionalized with a group selected from the group consisting of an acrylate, a methacrylate, an acryl amide, a methacryl amide, a styrene group, a vinyl ether, a vinyl ester, an allyl ether, an allyl ester, a maleimide, and an itaconate.

21. The radiation curable inkjet ink of claim 20, wherein the carboxylic acid is functionalized with a group selected from the group consisting of an acrylate, a methacrylate, an acryl amide, and a methacryl amide.

22. The radiation curable inkjet ink of claim 16, wherein the polymerizable compound is selected from the group consisting of acryloyl morpholine, cyclic trimethyl propene formol acrylate, isobornyl acrylate, dipropylene glycol diacrylate, trimethylol propane triacrylate, and 2-(vinylethoxy)ethyl acrylate.

23. The radiation curable inkjet ink of claim 16, further comprising a phenolic resin or a hydroxystyrene based resin.

24. The radiation curable inkjet ink of claim 16, further comprising a colorant.

25. The radiation curable inkjet ink of claim 16, further comprising a flame retardant.

26. A method of manufacturing a Printed Circuit Board (PCB) including an inkjet printing step wherein a radiation curable inkjet ink as defined in claim 16 is jetted and cured on a substrate.

27. The method of claim 26, wherein curing is carried out using UV radiation.

28. The method of claim 26, wherein a solder mask is provided in the inkjet printing step.

29. The method of claim 28, further comprising a heating step.

30. The method of claim 26, wherein the substrate is a dielectric substrate containing an electrically conductive pattern.
